(19) United States
(12) Patent Application Publication
(10) Pub. No.: US 2025/0101240 A1
(43) Pub. Date: Mar. 27, 2025

(54) METHOD AND SYSTEM FOR SYNTHESIS OF A THREE-DIMENSIONAL (3D)-PRINTABLE HYDROPHILIC SILICONE BASED ELASTIC COMPOSITE MATERIAL

(71) Applicants: Xiaowu (Shirley) TANG, Waterloo (CA); Sayan GANGULY, Kitchener (CA); Li Yan WONG, Waterloo (CA)

(72) Inventors: Xiaowu (Shirley) TANG, Waterloo (CA); Sayan GANGULY, Kitchener (CA); Li Yan WONG, Waterloo (CA)

(21) Appl. No.: 18/895,527

(22) Filed: Sep. 25, 2024

Related U.S. Application Data
(60) Provisional application No. 63/629,165, filed on Sep. 26, 2023.

(51) Int. Cl. C09D 11/03; C09D 11/102

(52) U.S. Cl. CPC C09D 11/03; C09D 11/102

(57) ABSTRACT

The disclosure is directed at a method of fabricating a hydrophilic silicone-based ink product for use in three-dimensional printing and the ink itself. The ink includes a hydrophilic silicone, at least one vinylic monomer, at least one multi-vinylic monomer and a water-based initiator.

### CROSS-REFERENCE TO OTHER APPLICATIONS

The disclosure claims priority from U.S. Provisional Application No. 63/629,165 filed Sep. 26, 2023 which is hereby incorporated by reference.

### FIELD

The disclosure is directed at non-extrusion three-dimensional (3D) printing and, more specifically, at a method and system for synthesis of a 3D-printable hydrophilic silicone based composite material.

### BACKGROUND

Three-dimensional printing is an additive manufacturing technique that has been emerging quickly as a new tool for the fabrication of three-dimensional structures in a layer-by-layer manner at a faster speed and lower fabrication cost than molding and machining. More specifically, Vat photopolymerization (VP) printing is well-known to have high printing accuracy and resolution and has emerged as a popular approach for the fabrication of delicate structures with tunable mechanical properties and improved surface quality.

In terms of inks that are used for 3D printing, hydrogels have been an attractive material for the fabrication of tissue-engineered structures due to their biocompatibility and water-rich properties, which are highly compatible with the conditions of the soft tissues in the human body, such as skin, cartilage, and tendons. However, most conventional hydrogels are mechanically weak and brittle due to the presence of an inhomogeneous polymer network, low polymer density, and/or small friction between polymer chains. As such, most conventional hydrogels fail to match the strength and flexibility found in most human organs and tissues.

Furthermore, current microfluidic devices are fabricated using silicone with hydrophobic surfaces and require an additional post-processing step, resulting in a longer fabrication process, to produce microfluidic devices with hydrophilic surfaces. The hydrophilicity acquired through the additional post-processing step is often not permanent and can be easily reversible.

Therefore, there is provided a novel method and system for synthesis of a 3D-printable hydrophilic silicone-based elastic composite material for non-extrusion 3D printing.

### SUMMARY

In one embodiment, the 3D-printable hydrophilic silicone based composite material of the disclosure has a low viscosity of and a high number of crosslinking sites simultaneously without impacting the mechanical properties of the silicone-based composite material. In one embodiment, by combining at least one vinylic monomer and at least one multi-vinylic monomer, multiple polymer networks are developed within the final material product for use with three-dimensional (3D) printing. In some embodiments, the composite material may be seen as a hydrogel, a scaffold or an elastomer.

In one aspect of the disclosure, there is provided a printing material product for use in non-extrusion three-dimensional (3D) printing including a hydrophilic silicone; at least one type of vinylic monomer; at least one type of multi-vinylic monomer; and a water-based initiator.

In another aspect, the ink product further includes at least one additive. In yet a further aspect, the at least one additive includes an additive with photoabsorption properties, an additive with mechanical property enhancements, an additive for photoinhibiting or an additive for photocuring depth tuning. In another aspect, the at least one additive includes a set of cellulose nanocrystals (CNC), colouring dyes, a hydrophilic nanofiller, clay, silica or radical inhibitors.

In a further aspect, the hydrophilic silicone includes at least one of a silicone grafted with hydrophilic functional groups, aminosilicone, methacryloyl silicone, polyalkene oxide silicone and hydroxylic silicone. In another aspect, the at least one vinylic monomer includes at least one of acrylamide monomers, hydrophilic vinylic monomers, acrylic acid, methacrylic acid, glycidyl methacrylate, 2-hydroxyethyl methacrylate (HEMA), 2-hydroxyethyl acrylate (HEA) and vinyl alcohol. In yet a further aspect, the at least one multi-vinylic monomer includes at least one of poly(ethylene glycol) dimethacrylate (PEGDMA), any hydrophilic di-acrylate, tri-acrylate, tetra-acrylate, penta-acrylate, hexa-acrylate or methacrylate ethylene glycol dimethacrylate, diethylene glycol dimethacrylate, 1,3-butanediol dimethacrylate and dipentaerythritol hexaacrylate. In yet another aspect, the water-based initiator comprises at least one of water-soluble derivatives of monoacylphosphine oxide (MAPO) or water-soluble derivatives of biscylphosphine oxide (BAPO). In yet a further aspect, the water-soluble derivatives of MAPO includes lithium phenyl (2,4,6-trimethylbenzoyl) phosphinate (LAP) or sodium diphenyl(2,4,6-trimethylbenzoyl) phosphine oxide (TPO-Na). In another aspect, the water-soluble derivatives of BAPO include BAPO-OLi or BAPO-ONa.

In another aspect of the disclosure, there is provided a method of fabricating an ink product for use in non-extrusion three-dimensional (3D) printing including mixing at least one type of vinylic monomer with a hydrophilic silicone to produce a first mixture; adding at least one type to multi-vinylic monomer to the first mixture to produce a second mixture; and adding a water-based initiator to the second mixture to produce the ink product.

In another aspect, the method further includes adding at least one additive. In yet a further aspect, adding at least one additive includes adding at least one of an additive with photoabsorption properties, an additive with mechanical property enhancements, an additive for photoinhibiting or an additive for photocuring depth tuning to the ink product. In another aspect, adding at least one additive includes adding at least one of a set of cellulose nanocrystals (CNC), colouring dyes, a hydrophilic nanofiller, clay, silica or radical inhibitors to the ink product.

In a further aspect, the hydrophilic silicone includes at least one of a silicone grafted with hydrophilic functional groups, aminosilicone, methacryloyl silicone, polyalkene oxide silicone and hydroxylic silicone. In yet another aspect, mixing at least one type of vinylic monomer with a hydrophilic silicone includes mixing at least one of acrylamide monomers, hydrophilic vinylic monomers, acrylic acid, methacrylic acid, glycidyl methacrylate, 2-hydroxyethyl methacrylate (HEMA), 2-hydroxyethyl acrylate (HEA) or vinyl alcohol with the hydrophilic silicone. In yet another aspect, adding at least one type of multi-vinylic monomer to the first mixture includes adding at least one of poly(ethylene glycol) dimethacrylate (PEGDMA), any hydrophilic di-acrylate, tri-acrylate, tetra-acrylate, penta-acrylate, hexa-acrylate or methacrylate ethylene glycol dimethacrylate, diethylene glycol dimethacrylate, 1,3-butanediol dimethacrylate or dipentaerythritol hexaacrylate to the first mixture. In a further aspect, adding a water-based initiator to the second mixture includes adding at least one of water-soluble derivatives of monoacylphosphine oxide (MAPO) or water-soluble derivatives of biscylphosphine oxide (BAPO) to the second mixture.

### DESCRIPTION OF THE DRAWINGS

Some embodiments of the present disclosure are illustrated as an example and are not limited by the figures of the accompanying drawings, in which like references may indicate similar elements and in which:

FIG. 1a is a schematic diagram of one embodiment of a 3D-printable hydrophilic-silicone material or ink product;

FIG. 1b is a schematic diagram of another embodiment of a 3D-printable hydrophilic-silicone material or ink product;

FIG. 2a is a flowchart showing one embodiment of a method of fabricating or synthesizing a 3D-printable hydrophilic-silicone material of ink product;

FIG. 2b is a schematic diagram of the methacrylation of aminosilicone and methacryloyl groups;

FIG. 2c is a ¹H-NMR spectra of aminosilicone and functional groups of aminosilicone after grafting with methacryloyl group;

FIG. 2d is a schematic diagram of the chemical structure of acrylamide monomers;

FIG. 2e is a schematic diagram of a siloxane backbone of SilMA;

FIG. 2f is a ¹H-NMR spectra of SilMA with different dosages of acrylamide monomers (AA);

FIG. 2g is a graph showing transmittance of the pre-gel solutions of SilMA with different dosages of AA and PEGDMA in the UV-visible region ranges from 300 to 750 nm;

FIG. 2h is a graph showing shear viscosity of a SilMA/AA composite pre-gel solution against shear rate when added with different dosages of AA with and without 0.5 wt % PEGDMA;

FIG. 3a is a graph showing absorbance of 0.1 wt % lithium phenyl (2,4,6-trimethylbenzoyl) phosphinate (LAP) and 1 wt % cellulose nanocrystals (CNC) in water from 300 to 700 nm;

FIG. 3b is a graph showing transmittance of a pre-gel solution without and with 0.5 wt % of LAP followed by the inclusion of 0 to 10 wt % of CNC from 300 nm to 500 nm;

FIG. 3c is a graph showing amount of light absorbed by pre-gel solution and LAP, and scattered by CNC, respectively, when added with 0 to 10 wt % of CNC;

FIG. 3d is graph showing shear viscosity of the pre-gel solution with 0 to 5 wt % of CNC with increasing shear rate from 0 to 10 s⁻¹;

FIG. 3e is a graph showing storage modulus (G′), loss modulus (G″) and tan (δ) of pre-gel solution with 0 and 1 wt % of CNC upon ultraviolet (UV) exposure for 20 seconds;

FIG. 3f are microscope images of homogeneous distribution of 1 wt % CNC in the hydrophilic silicone composite pre gel solution under 10× and 20× magnification using inverted microscope;

FIG. 4a is a microscope image of SLA-printed SilMA/AA/PEGDMA hydrogel showing a light exposure of 2 seconds for the bottom layer;

FIG. 4b is a microscope image of SLA-printed SilMA/AA/PEGDMA hydrogel showing a light exposure of 5 seconds for the bottom layer;

FIG. 4c is a microscope image of SLA-printed SilMA/AA/PEGDMA hydrogel showing a light exposure of 40 seconds for the bottom layer;

FIG. 4d is a microscope image of SLA-printed SilMA/AA/PEGDMA hydrogel showing a light exposure of 2 seconds for each layer;

FIG. 4e is a microscope image of SLA-printed SilMA/AA/PEGDMA hydrogel showing a light exposure of 5 seconds for each layer; and

FIG. 4f is a microscope image of SLA-printed SilMA/AA/PEGDMA hydrogel showing a light exposure of 10 seconds for each layer.

### DETAILED DESCRIPTION OF THE EMBODIMENTS

The disclosure is directed at a method for synthesis or production of a three-dimensional (3D)-printable hydrophilic silicone-based elastic composite material or ink and at the composition of the material or ink. In one embodiment, the ink product of the disclosure includes a hydrophilic silicone, at least one vinylic monomer, at least one multi-vinylic monomer and a water-based initiator. In other embodiments, the ink may also include additives, such as, but not limited to, cellulose nanocrystals (CNC), clay nanoparticles, and silica nanoparticles. The ink product of the disclosure is designed for use in non-extrusion 3D printing applications or uses such as, but not limited to, Vat photopolymerization (VP) printing. In some embodiments, the ink product may be seen as a hydrogel, a scaffold or an elastomer.

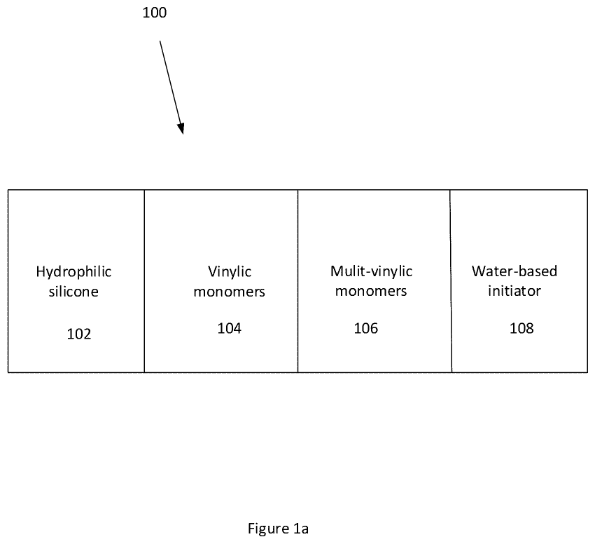

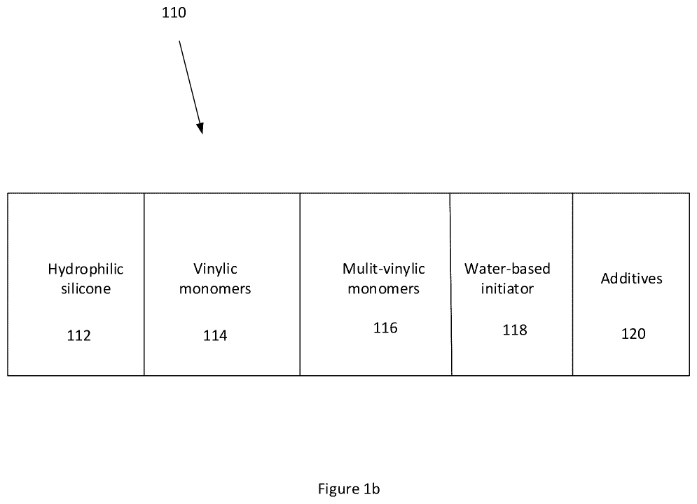

Turning to FIG. 1a, a schematic diagram of a 3D-printable hydrophilic silicone-based ink or composite material for non-extrusion 3D printing is shown. In the current embodiment, the ink 100 includes different components in different percentages, the components including a hydrophilic silicone 102, at least one type of vinylic monomer 104, at least one type of multi-vinylic monomer 106 and a water-based initiator 108. In some embodiments, the hydrophilic silicone 102 may be any silicone grafted with hydrophilic functional groups such as, but not limited to, aminosilicone, methacryloyl silicone, polyalkene oxide silicone, hydroxylic silicone and the like. In some embodiments, the at least one type of vinylic monomer 104 may be selected from methacrylate anhydride, acrylamide monomers, hydrophilic vinylic monomers such as, but not limited to, acrylic acid, methacrylic acid, glycidyl methacrylate, 2-hydroxyethyl methacrylate (HEMA), 2-hydroxyethyl acrylate (HEA) or vinyl alcohol. In some embodiments, the at least one type of multi-vinylic monomer 106 may be poly(ethylene glycol) dimethacrylate (PEGDMA), any hydrophilic di-acrylate, tri-acrylate, tetra-acrylate, penta-acrylate, hexa-acrylate or methacrylate such as, but not limited to, ethylene glycol dimethacrylate, diethylene glycol dimethacrylate, 1,3-butanediol dimethacrylate or dipentaerythritol hexaacrylate, In some embodiments, the water-based, or water-soluble, initiator 108 may be any water-soluble photoinitiator such as, but not limited to, water soluble derivatives of monoacylphosphine oxide (MAPO) (i.e. lithium phenyl (2,4,6-trimethylbenzoyl) phosphinate (LAP), or sodium diphenyl (2,4,6-trimethylbenzoyl) phosphine oxide (TPO-Na)) or biscylphosphine oxide (BAPO) (e.g. BAPO-OLi or BAPO-ONa). In other embodiments, a water-based initiator being water soluble and bio-compatible with a long ultraviolet (UV) wavelength may be used.

An advantage of the disclosure is the provision of a hydrophilic silicone-based ink product with at least one of a low pre-gel solution viscosity, a high light penetration depth (pre-gel transparency) and a high amount of photocrosslinking sites for rapid photocrosslinking for non-extrusion 3D-printing.

Turning to FIG. 1b, a schematic diagram of another embodiment of a hydrophilic silicone-based ink product for non-extrusion 3D printing is shown. In the current embodiment, the ink 110 includes different components in different percentages, the components including a hydrophilic silicone 112, at least one type of vinylic monomer 114, at least one type of multi-vinylic monomer 116, a water-based initiator 118 and additives 120. Additives may include, but are not limited to, cellulose nanocrystals (CNC), additives with photoabsorption properties such as, but not limited to, colouring dyes and/or mechanical properties enhancement such as, but not limited to any hydrophilic nanofiller can be added into the formulation. Examples of hydrophilic nanofillers include clay or silica. Other additives, such as, but not limited to, radical inhibitors to prevent or reduce the likelihood of premature gelation may also be added to the hydrophilic silicone-based ink.

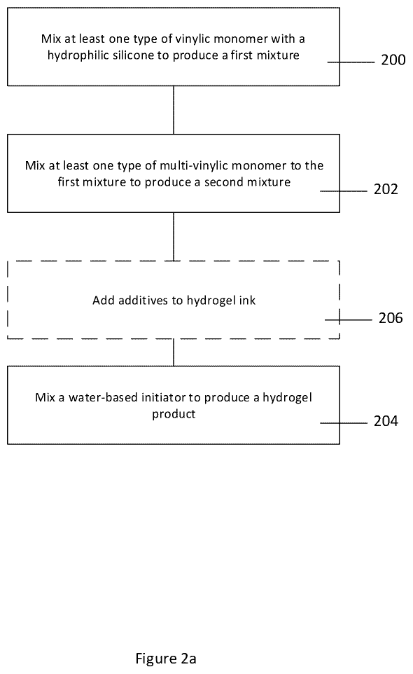

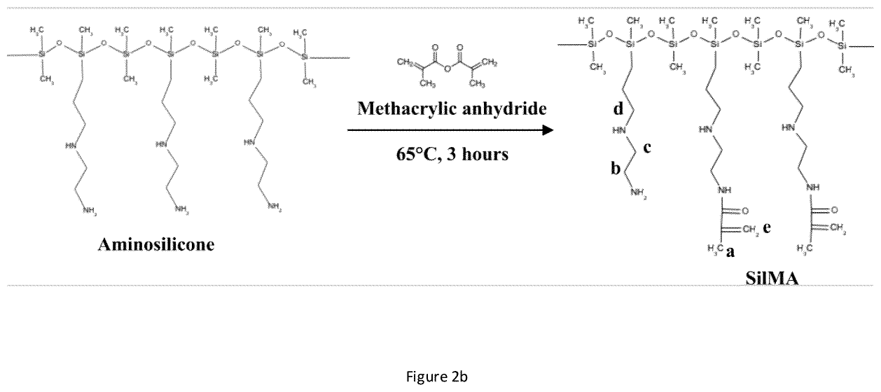

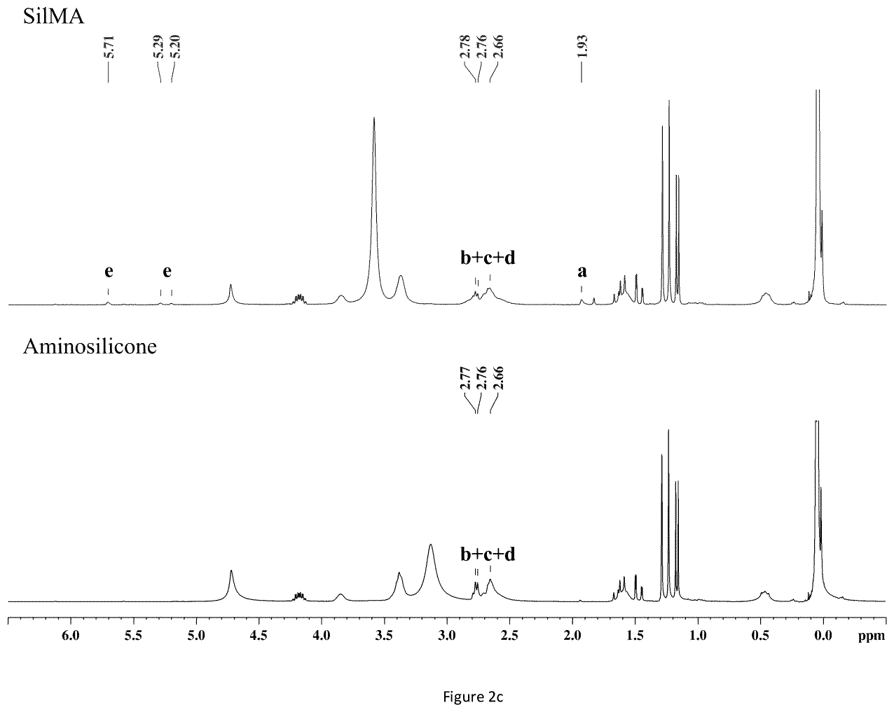

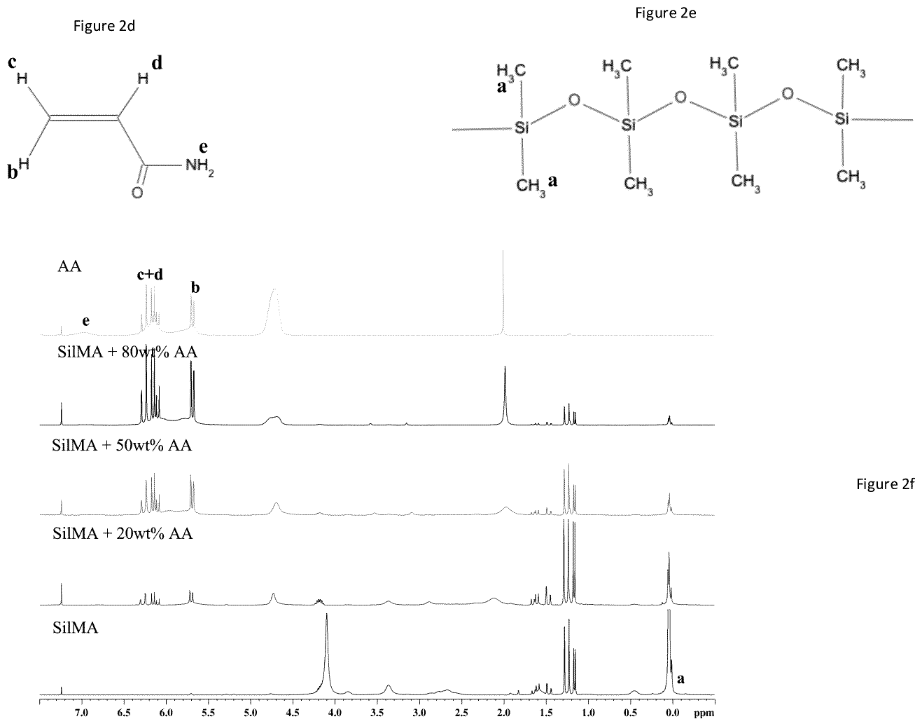

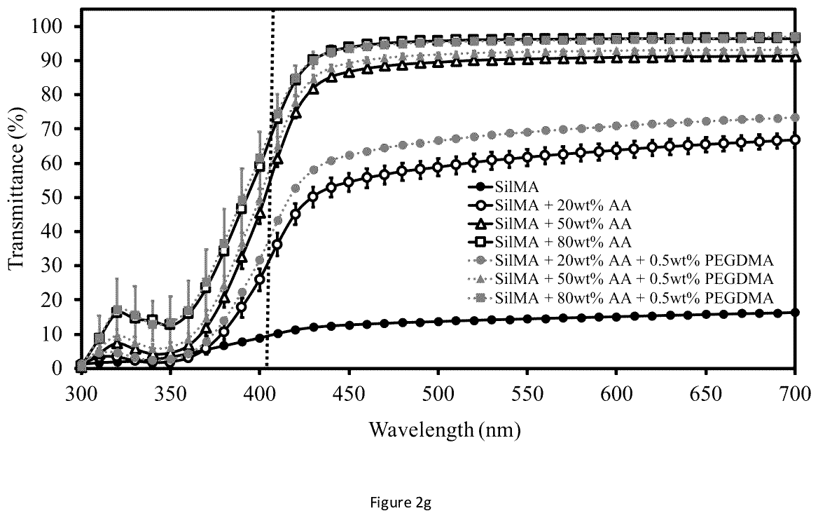

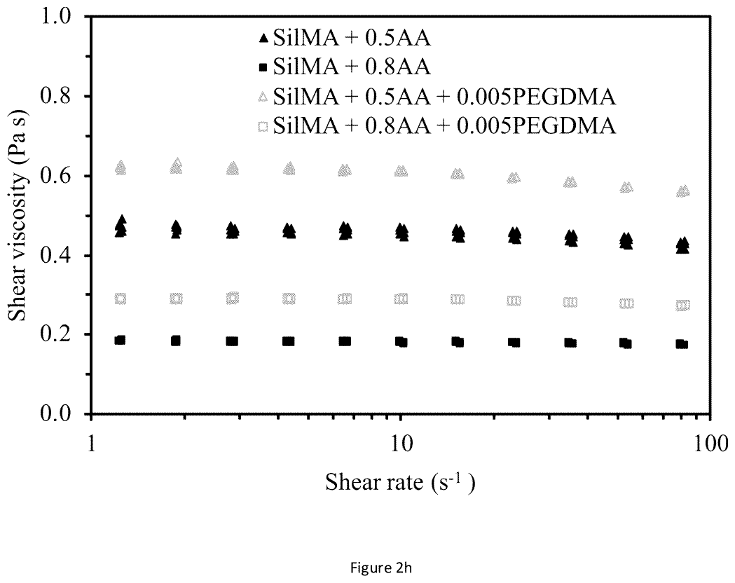

Turning to FIG. 2a, a flowchart showing a method of producing a 3D-printable hydrophilic silicone-based ink or material for use in non-extrusion 3D printing is shown. Initially, a hydrophilic silicone is mixed with at least one type of vinylic monomer (200) to produce a first mixture or a silicone/vinylic mixture. In some embodiments, the hydrophilic silicone may be mixed with two or more different types of vinylic monomers depending on the selected hydrophilic silicone or desired characteristics of the final ink product. At least one type of multi-vinylic monomers is then mixed to the first mixture to produce a second mixture (202). The second mixture may be seen as a silicone/vinylic/multi-vinylic mixture.

In the current embodiment, a water-based initiator is then added to the second mixture to produce one embodiment of a 3D-printable hydrophilic silicone-based ink or material (204). While the method of FIG. 2a appears to provide a chronological order with respect to when components are added to produce the ink product, it is understood that the components may be added in any order whereby after adding each of the components, a final ink composition including a hydrophilic silicone, at least one type of vinylic monomer, at least one type of multi-vinylic monomer and a water-based initiator is produced. It is understood that in all embodiments, the water-based initiator or photoinitiator is added last.

In some embodiments, additives, such as CNC or coloring dye, may be added to the ink (206) although this is not necessary in each embodiment of the disclosure. This is performed before the water-based initiator is added to the second mixture (204). As this is not required in every embodiment, the addition of additives is shown using dotted lines.

In one specific embodiment of the method of FIG. 2a, which may be seen as the fabrication of a hydrophilic silicone-based hydrogel, aminosilicone (hydrophilic silicone) is modified or mixed with methacrylic anhydride (one type of vinylic monomer) to graft the amino groups with methacryloyl groups. A schematic diagram of polymer methacrylation of aminosilicone with methacrylic anhydride is shown in FIG. 2b. As aminosilicone generally lacks readily available functional groups to form covalent crosslinking upon photoinitiation, by mixing it with methacrylic anhydride, the inclusion of methacryloyl groups with a C═C bond enable the first mixture, which may be referred to as a SilMA mixture for this specific embodiment, to form a first interpenetrating polymer network via covalent crosslinking upon photoinitiation.

In experiments, as shown in the ¹H-NMR spectra of FIG. 2c, the SilMA mixture was observed to have a reduction in peak signals for the aminoethylaminopropyl group at 2.66, 2.76, and 2.78 ppm (points b, c and d) accompanied by the emergence of new peak signals for methyl protons of the methacrylamide group at 1.93 ppm (point a) and acrylic protons of the methacrylamide group at 5.20, 5.29, and 5.71 ppm (point e).

In this specific embodiment, acrylamide monomers (a second type of vinylic monomer) was added to the SilMA mixture. As will be understood, the addition of a second or more type of vinylic monomers may be dependent on the selected hydrophilic silicone or desired properties of the final ink product. For this specific embodiment, addition of the acrylamide monomers (AA) lowers the overall viscosity of the SilMA pre-gel solution or mixture and increases the availability of crosslinking sites for rapid crosslinking to occur within the SilMA pre-gel solution (or mixture) upon photoinitiation. This mixture may also be seen as another variant of the first mixture or may be referred to as a SilMA/AA mixture for this specific embodiment. FIG. 2d is a schematic diagram of the chemical structure of acrylamide monomers and FIG. 2e is a schematic diagram of a siloxane backbone of SilMA.

The addition of AA to the SilMA mixture may be characterized by ¹H-NMR as shown in FIG. 2f. As the dosage of AA increases, the peak signals representing the vinyl protons of AA at 6.23, 6.17, and 5.71 ppm (points b, c and d) increase proportionally with the reduction in peak signal for the methyl group in the siloxane backbone of SilMA at 0.043 ppm (point a). This confirms that the AA content increases with respect to SilMA in the overall polymer mixture upon the addition of AA. As a result, the addition of AA results in additional vinyl groups which increase the overall number of available crosslinking sites in the first mixture. The presence of abundant crosslinking sites in the SilMA/AA pre-gel solution or mixture promotes crosslinking to quickly occur which is a characteristic highly sought after for inks to be used for VP printing or other non-extrusion 3D-printing applications.

In this specific embodiment, as can be seen in FIG. 2g, the addition of AA with and without PEGDMA to the SilMA mixture also increases the light penetration depth of the SilMA pre-gel solution or mixture as reflected by the higher percentage of light transmitted through the SilMA pre-gel solution. The higher the dosage of AA added to the SilMA mixture, the higher the light transmittance across the UV-visible region from about 300 nm to about 750 nm. For this embodiment, the addition of AA to the SilMA mixture improves the VP-printability of the SilMA ink product by increasing the number of crosslinking sites, increasing the light transmittance at 405 nm, and reducing the viscosity of the SilMA pre-gel solution.

For this specific embodiment, PEGDMA (a type of multi-vinylic monomer) was added to the SilMA/AA mixture. PEGDMA is a multi-vinylic monomer that has an ability to develop a network due to its structure. Multi-vinylic monomers may also be seen as cross-linking monomers. In this specific embodiment, PEGDMA enables the formation of branched polyacrylamide to assist in forming a second interpenetrating polymer network within the SilMA/AA composite hydrogel upon photoinitiation. While other crosslinking monomers are contemplated, for the current embodiment, selection of PEGDMA improves the elasticity of the SilMA/AA mixture due to the presence of the long hydrophilic chain in between the methacrylate groups. Although the addition of 0.5 wt % of PEGDMA to the different doses of AA slightly deviates the light transmittance at 405 nm (as shown in FIG. 2g) and the shear viscosity (FIG. 2h) of the SilMA/AA composite pre-gel solution, the SilMA/AA/PEGDMA mixture or second mixture still has a significantly lower shear viscosity and higher light transmittance at 405 nm than the SilMA mixture.

A water-based initiator is then added to the second mixture for this specific embodiment. In some embodiments, the water-based initiator is an LAP initiator. In general, the water-based initiator or photoinitiator enables the formation of radicals to initiate the polymerization process. More specifically, the initiator moiety splits and form radicals upon experiencing a triggering event such as due to heat or light. For LAP, the triggering event is a presence of light. The initiator radicals then interact with the C═C bonds of the vinylic monomer to initiate the polymerization process. The different vinylic monomers then polymerize to form polymer chains, thereby generating a three-dimensional polymer network.

While not necessary in each embodiment, in some embodiments, CNC may be added to the mixture. The need for the addition of CNC may be determined based on a use or application of the ink product or desired characteristics of the final ink product.

In the specific embodiment, CNC was added to the SilMA/AA/initiator ink product to address overcuring by reducing the light penetration depth to improve printing accuracy and resolution, where required. In experiments, the UV light emitted by the VP printer when using the ink of the disclosure (including CNC) had a wavelength of 405 nm. In some embodiments, the choice of additives used for photocuring depth tuning conferred suitable absorption properties at 405 nm to effectively reduce the light penetration depth of the pre-gel solution or ink at a wavelength best complemented to that of the VP printer used for experiments/ink testing.

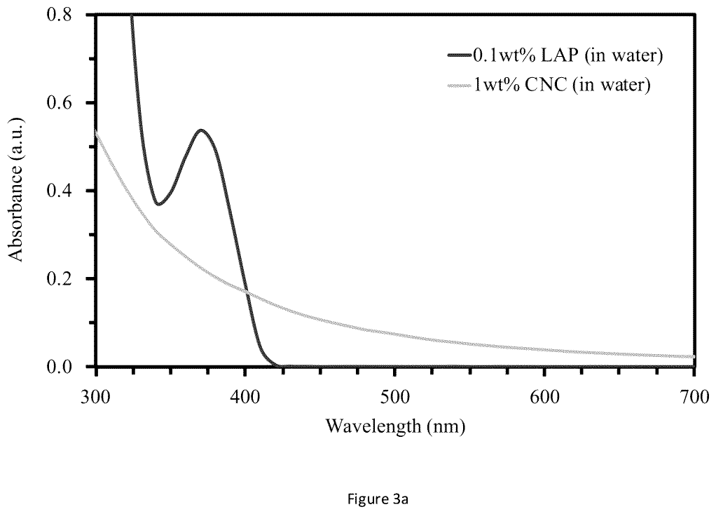

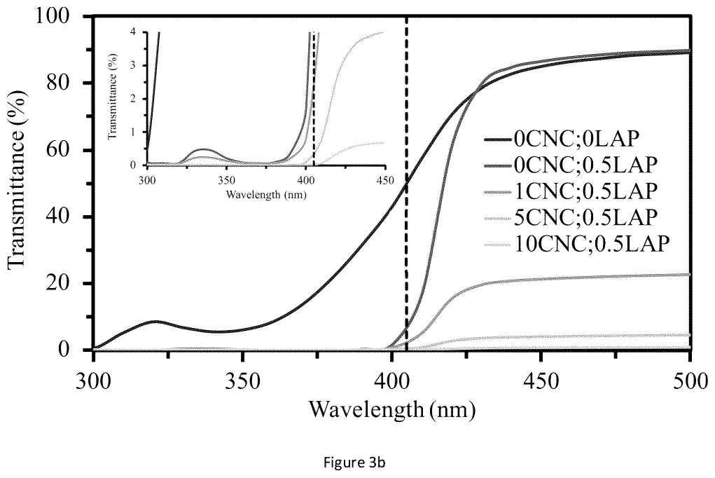

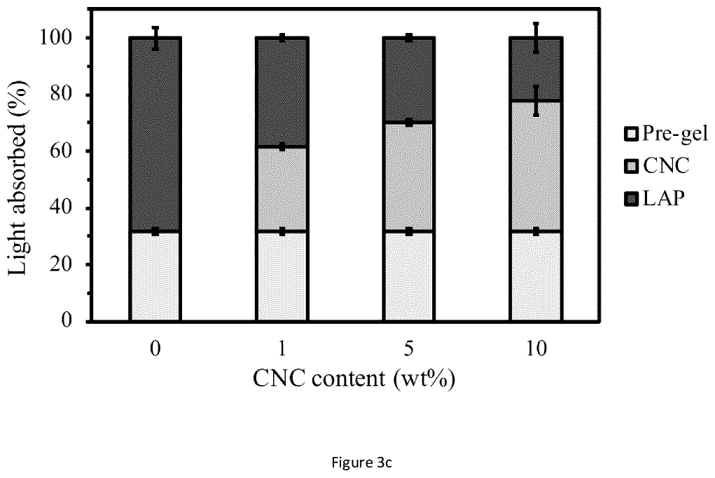

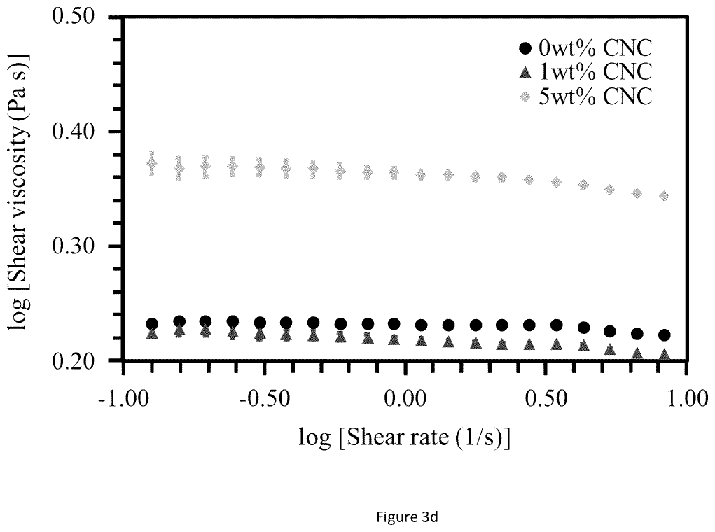

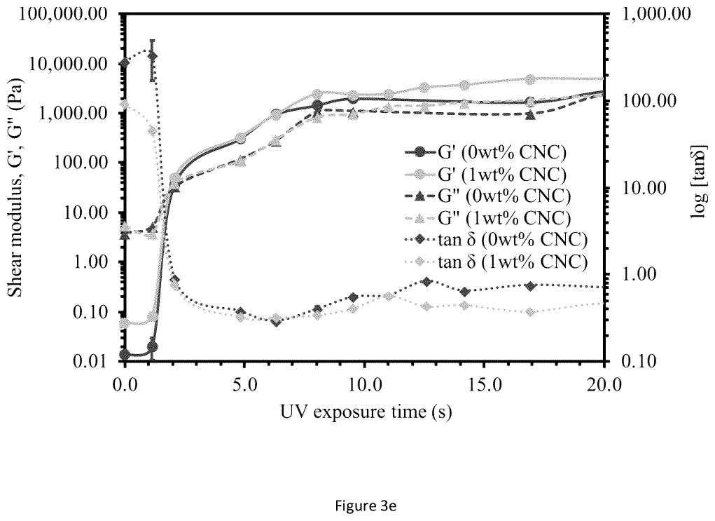

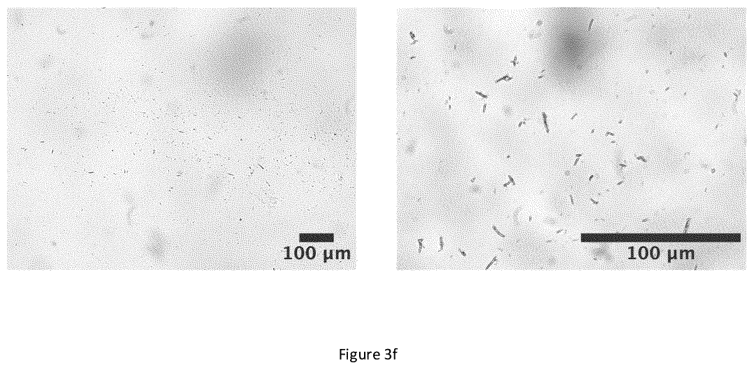

Based on experiments, CNC was found to exhibit a wide range of absorbance from 300 to 700 nm as shown in FIG. 3a. The light transmittance of the pre-gel solution or ink product at 405 nm was observed to reduce proportionally with the increasing CNC content from 1 to 10 wt % as shown in FIG. 3b. The percentage of light scattered by CNC was further quantified by translating the difference between the light transmittance at 405 nm of the respective pre-gel solutions measured in FIG. 3b to a ratio in percentage for comparison.

For ink products without CNC or prior to the incorporation or addition of CNC, the addition of the water-based initiator, LAP, resulted in a reduction of light transmittance from 300 to 420 nm, as shown in FIG. 3b, which aligns with the absorption range of LAP as a photoinitiator. The resulting difference in transmittance at 405 nm of the initial pre-gel solution with and without 0.5 wt % of LAP was used to derive the amount of light absorbed by 0.5 wt % of LAP and the initial pre-gel solution, as shown in FIG. 3c. By assuming the amount of light absorbed by the SilMA/AA/initiator mixture remains constant, the further reduction in transmittance due to the addition of CNC is regarded as the amount of light scattered by CNC itself. As can be seen from FIG. 3c, the amount of light made available to LAP was found to decrease from 68.0±3.8% to 38.3±1.1%, 29.9±1.0%, and 22.3±5.1% as the amount of light scattered by CNC increases with the CNC content increasing from Owt % to 1 wt %, 5 wt %, and 10 wt %, respectively. This shows that the addition of CNC is able to limit the amount of light for photoinitiation with its light-scattering properties. Therefore, the amount of CNC may be selected such that it is able to reduce the likelihood of an overdose of photoscatterer often causes the undercuring of printing layers, which results in either a structurally weak construct with layer misalignments or a complete failure in printing due to insufficient photocuring.

The addition of CNC also affects the viscosity of the pre-gel solution or ink product. For VP printing, it is beneficial to use an ink product with a low viscosity for better flowability to effectively replenish the printing layer and to minimize or reduce the turbulence caused by the movement of the build plate during the VP printing process. As shown in FIG. 3d, the shear viscosity of the ink product was found to increase with the CNC content due to the formation of hydrogen bonding between the hydroxyl groups on the surface of CNC with its surrounding matrix of pre-gel solution. In a specific embodiment, an ink product with 1 wt % of CNC was selected for experimentation with the gel point evaluation.

Gel point evaluation assists to determine a minimum or low UV exposure time required per printing layer to form a solid gel via gelation upon photocuring. Due to the nature of VP printing, the UV exposure time of the pre-gel solution for each printing layer is often limited to only a few seconds. Thus, it would be highly favourable for a pre-gel solution or ink product to have a gel point within a few seconds for rapid curing properties. In parallel to that, the gel point of the pre-gel solution was determined based on the changes in the rheological behavior of the pre-gel solution with the UV exposure time. Particularly, the gel point was identified as the point where the storage modulus (G′) crossover with the loss modulus (G″), for which G′=G″, as the pre-gel solution solidifies from the liquid pre-gel state (G′<G″) to the solid gel state (G′>G″) upon UV exposure. Based on FIG. 3e, the addition of 1 wt % of CNC demonstrates a similar gel point of approximately 2 seconds as opposed to the pre-gel solution with 0 wt % of CNC, which indicates that the addition of 1 wt % of CNC has no negative impact on the rapid curing properties of the pre-gel solution. By considering the minimal impact on the viscosity and gel point of the pre-gel solution, 1 wt % of CNC was employed as the optimum dosage of photoscatterer for the following evaluation of the printing accuracy and resolution of the formulated pre-gel solution. Overall, the 1 wt % of CNC was observed to be homogeneously distributed and dispersed within the polymer matrix of the pre-gel solution as shown in FIG. 3f.

Experiments involving 3D printing using one specific embodiment of an ink generated with the method taught above were performed. In the experiments, an ink including a combination of aminosilicone, vinylic monomers (methacrylate anhydride and acrylamide monomers), divinylic monomers (PEGDMA) and a water-based initiator was used. The ink may be referred to as SilMA/AA/PEGDMA or SilMA/AA/PEGDMA composite hydrogel.

For the 3D printing experiments, the ultraviolet (UV) light exposure time per printing layer for both the bottom and normal layers of the printed 3D structure was optimized or improved to better suit the printability of the SilMA/AA/PEGDMA composite hydrogel or ink product. The bottom layers may be seen as the initial printing layers of the structure while the normal layers may be seen as the remaining printed layers of the 3D structure. Ideally, each layer in a 3D structure is cured with a light penetration depth higher than the layer height to allow the attachment of two consecutive or adjacent layers via gelation and integration. The exposure time for the bottom layers to light is usually longer than for the normal layers to ensure that the base of the printed 3D structure is well attached to the build-plate.

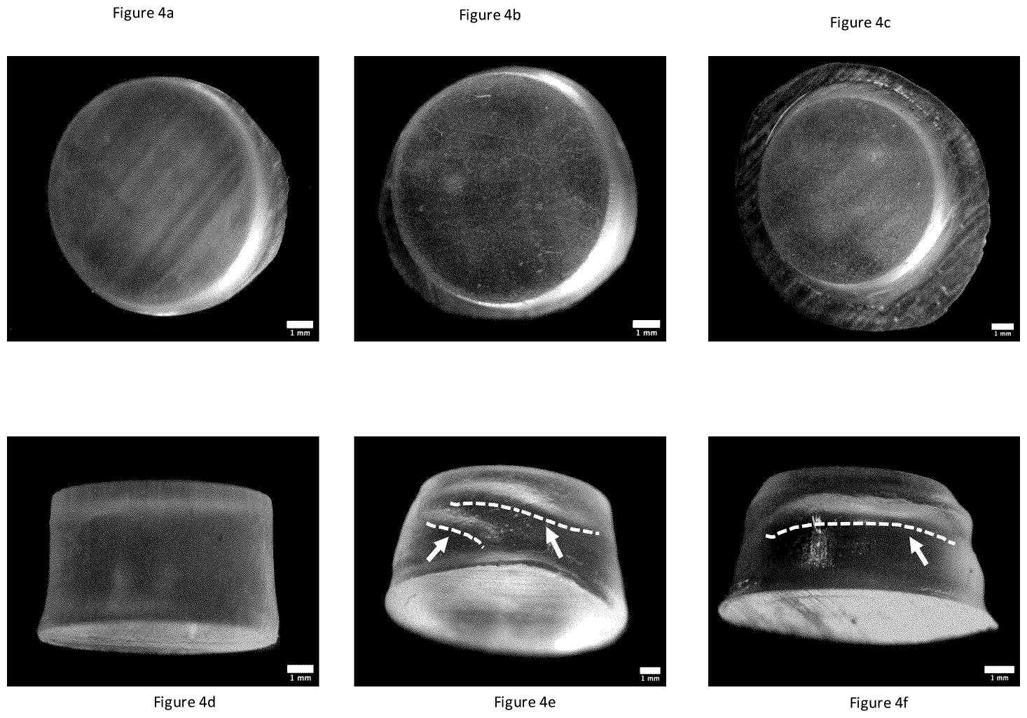

Due to the high transparency of the SilMA/AA/PEGDMA composite hydrogel, an exposure time longer than two seconds causes excessive light to penetrate beyond the designated layer thickness and forms an overcured ring such as shown in FIGS. 4b and 4c. Based on FIG. 4a, the two seconds of exposure time for the bottom layers did not eliminate or remove the overcured ring as slightly overcured fragments were observed at the bottom of the printed 3D structure. This is in line with the two seconds gel point of the SilMA/AA/PEGDMA composite hydrogel, for which the composite hydrogel requires at least two seconds of UV exposure to form a solid gel. As for the normal layers, two seconds of exposure time per layer creates a printed structure with a smooth surface as shown in FIG. 4d. In contrast, layer delamination was observed on the printed 3D structures as the exposure time increased as shown in FIGS. 4e and 4f. As such, two seconds of exposure time for both the bottom and normal layers were applied for all the printed structures to achieve favorable results.

In some embodiments, the incorporation or addition of AA and PEGDMA to the SilMA mixture to create a second polymer network provides an improvement over an ink product only including SilMA as an VP-printable ink product. The addition of AA enhances the photocrosslinking properties of the composite hydrophilic silicone-based pre-gel ink product by elevating the number of overall crosslinking units and the transparency of the pre-gel solution. Furthermore, the addition of PEGDMA lowers the shear viscosity of the ink product of the disclosure to provide an improved flowability of the ink product or pre-gel solution when used in a VP-printing process. As discussed above, a SilMA/AA/PEGDMA composite pre-gel solution requires only two seconds of exposure time per printing layer to produce a three-dimensional structure with a smooth surface. A printing resolution of X, Y, and Z up to 100 μm was achieved with the ink product using VP printing. In terms of physical properties, the printed SilMA/AA/PEGDMA composite hydrogel with 80 wt % of AA can retain a high amount of water with an equilibrium swelling degree at 104.4±3.2%. Furthermore, the composite hydrogels were hydrophilic with a contact angle below 90°. In terms of mechanical properties, the increase in strength and elasticity of the composite hydrogel with the AA content enables tunable mechanical properties to better cater to the functionality of the biomimetic structure.

For the experimental printing of articular cartilage, the composite hydrogel with 50 wt % and 80 wt % of AA was found to have a compressive modulus of 0.28±0.04 MPa and 0.72±0.05 MPa that highly resembles that of superficial and deep zones of articular cartilage, respectively. Additionally, the developed composite hydrogel was found to have excellent shape recovery properties. In future, there is a potential for the ink product of the disclosure to be used in the development of biomimetic structures due to at least one of the ink product's swelling properties, hydrophilicity, viscoelasticity, tunable mechanical properties, and durability.

Following the optimization or determination of optimal printing parameters, the printing resolution of the SilMA/AA/PEGDMA composite hydrogel using VP printing was evaluated with known test models. In one experiment, the evaluation was performed on a composite hydrogel that included SilMA with 80 wt % of AA and 0.1 wt % of PEGDMA as this combination of components provided an improved printability and flowability compared with SilMA with either 20 wt % or 50 wt % of AA. In other words, it was determined that a higher wt % of AA within the composite hydrogel provides improved printability and flowability, however, it is understood that there may be embodiments which have a lower wt % of AA.

Generally, a positive deviation from the true value indicates that the printed structure appears to be thicker than expected while a negative deviation from the true value indicates that the printed structure appears to be thinner than expected. In terms of X and Y resolution, all the dimensions of the test models were printed using VP and the composite hydrogel. It was determined that the printing accuracy reduces with an increasing deviation as the printing dimension decreases. On average, the deviation from true value fluctuates near zero deviation up to 300 μm. Thereafter, the printing dimension deviates up to 7.1±10.8% for 200 μm, 8.9±15.0% for 100 μm, and 13.2±18.4% for 50 μm for X resolution, and 4.5±6.7% for 200 μm, 4.2±11.0% for 100 μm, and 14.6±16.4% for 50 μm for Y resolution. As for Z resolution, dimensions below 100 μm are barely distinguishable with deviations up to 6±23% for 80 μm, −27±17% for 60 μm, −13±24% for 40 μm, and the height at 20 μm is not identifiable. The general trend of positive deviation for X and Y resolution aligns with the observation of the slightly overcured printing. Overall, the SilMA/AA/PEGDMA composite hydrogel was determined to have an X, Y, and Z printing resolution of up to 100 μm with an average positive and negative deviation lesser than 10% using VP printing.

In some embodiments, the disclosure may be used in non-extrusion 3D printing of human body parts. In experiments, it was determined the hydrogel or ink product of the disclosure was able to maintain a high-water content intended for tissue-mimetic structures. Furthermore, the hydrophilic nature of the disclosure also provides a benefit to the printing of tissue-mimetic structures for the promotion of cell attachment and proliferation. The swelling capacity of hydrogels is closely related to the hydrophilicity of hydrogels as the hydrophilic functional groups in the hydrogel are responsible for water absorption.

Along with improved swelling capacity and hydrophilicity, the hydrogel or ink product of the disclosure also has strength and elasticity which mimic the functionality of a biomimetic structure as most human organs are made up of flexible soft tissues with a variety of elasticity among the different human organs. As such, upon the addition of AA, the elasticity of the SilMA hydrogel heightens as the elastic component in the polymer network of the SilMA/AA/PEGDMA composite hydrogel increases.

In reference to articular cartilage, both the ultimate compressive and cyclic compressive properties of the composite hydrogel were evaluated in order to assess its suitability to be used as an alternative material for shock absorption and wear resistance to withstand the compressive forces exerted during joint movement. In experiments, it was determined that the modulus of the SilMA/AA/PEGDMA composite hydrogel was found to increase proportionally with the dosage of AA, which indicates that the compressive strength increases with the AA content. With the tunable compressive properties of the composite hydrogel with respect to the AA content, the composite hydrogel was found to have a modulus of 0.28±0.04 MPa and 0.72±0.05 MPa at 10% when added with 50 wt % and 80 wt % of AA, which closely mimics the compressive modulus of the superficial and deep zone of articular cartilage, accordingly.

In terms of durability, the SilMA/AA/PEGDMA composite hydrogel was observed to have a comparable compressive modulus throughout the 10 continuous compression cycles. The excellent recovery of the composite hydrogel after withstanding compression at a constant displacement for 10 cycles further exhibits the potential of the composite hydrogel to be used as an articular cartilage substitute.

In another specific embodiment of the method of FIG. 2a, aminosilicone was reacted with MA to produce SilMA. In this specific embodiment, the aminosilicone with an active polymer content of 70% was dispersed in water with a ratio of 1.5 parts of aminosilicone to 1 part of water to obtain a pre-gel solution with a concentration of 1 g mL⁻¹. After the dispersion of aminosilicone in water at 65° C., 5 wt % of MA calculated based on the active polymer content was added while stirring. The reaction mixture was stirred at 65° C. for another 3 hours in the dark with a closed cap for direct substitution to occur between the amino groups presenting on the side chains of aminosilicone and the methacryloyl groups in MA. The reaction mixture was then left to cool.

The composite pre-gel solution was further prepared by adding AA as an additional vinylic monomer units to the SilMA followed by PEGDMA as crosslinking or divinylic monomers to form a second crosslinking network in addition to SilMA upon photoinitiation. The SilMA was stirred with 20 wt % to 80 wt % of AA for about 1 hour or until fully dissolved before dosing in 0.01 wt % to 0.5 wt % of PEGDMA to multiple ink products with different component percentages. After the dissolution of the pre-gel solution, 0.5 wt % of LAP was added and stirred at room temperature (22±2° C.) for 1 hour in the dark. All the dosage in wt % mentioned in this section was calculated based on the total pre-gel solution mass before the addition of the respective components.

For 3D printing, three-dimensional structures were printed with a VP printer. Prior to printing, a three-dimensional structure was designed. The pre-gel solution was poured into the vat and the three-dimensional structure was printed on the build plate with a 100% UV power of 45 J s⁻¹ at 405 nm. The structure was printed with a layer thickness of 0.05 mm at a lift speed of 4 to 6 mm s⁻¹ and a retract speed of 6 to 8 mm s⁻¹ with 6 bottom layers. The exposure time per layer for the bottom layers varied from 2 to 40 s and for the normal layers was varied from 1 to 10 s. Once the printing process was finished, the printed structure was removed from the build plate and washed in water at 800 to 900 rpm for 30 s to remove any remaining uncured pre-gel solution on the printed structure. Then, the printed structure was post-cured in a UVP crosslinker at 4000 μJ cm⁻² for 0 to 5 minutes. Finally, the cured composite hydrogel was characterized with Fourier transform infrared spectroscopy, FTIR.

For printing resolution testing, the X, Y, and Z resolutions of the composite hydrogel were evaluated with previously developed test models with a resolution of up to 50 μm for X and Y resolution and up to 20 μm for Z resolution. The printed test models were photographed with a digital microscope and measured. For the experiments, about 40 to 80 intra- and inter-sample measurements were made and reported as an average. The deviation of the printed width for X and Y resolution and the printed height for Z resolution were calculated with the equations below:

$${Deviation}_{X or Y} ( \% ) = \frac{{W}_{1} - {W}_{0}}{{W}_{0}} \times 100 \% \qquad ( 3 )$$

$${Deviation}_{Z} ( \% ) = \frac{{H}_{1} - {H}_{0}}{{H}_{0}} \times 100 \% \qquad ( 4 )$$

where W₀ and W₁ denote the width designed in the test model and the actual width printed for X and Y resolution, respectively, while H₀ and H₁ denote the actual height designed in the test models and the actual height printed for Z resolution, respectively.

For a swelling test, the swelling behavior of the hydrogel was investigated in water at room temperature (22±2° C.). During swelling, the weight changes of the hydrogel were recorded at regular time intervals to calculate the swelling degree (SD) with the following equation:

$$SD \% = \frac{{W}_{t} - {W}_{0}}{{W}_{0}} \times 100 \% \qquad ( 5 )$$

where W₀ and Wₜ represent the weight of the hydrogel before swelling and after swelling at a predetermined time, respectively. The swelling test was conducted until the hydrogel reached a state of equilibrium. In order to investigate the swelling behavior of the hydrogel in human physiological conditions, the swelling test was further conducted with the same method in water (as control), 0.84% NaCl solution (mimicry of general body fluid), and a mixture of 30 mg/ml BSA and 3 mg/ml of NaHa in PBS at pH 7.1 to 7.4 (mimicry of synovial fluid), respectively, at 37° C. in a water bath.

For contact angle testing, the surface of the swollen hydrogel was pat dry with paper towels and a 10 μL of water drop was dispensed onto the surface of the swollen hydrogel followed by photographed with a digital camera. The contact angle was further analyzed with ImageJ. A total of 20 readings were recorded from the same sample to rule out any possible errors in measurement. The measurements were repeated with a different sample and the values were reported as an average.

For compression testing. the ultimate compressive strength of the hydrogel was evaluated using a universal tensile machine. The hydrogel sample was compressed at a speed of 0.05 mm s⁻¹ with a 1000N load until the hydrogel sample fractures and the ultimate compressive strength of the respective hydrogel sample was recorded. The cyclic compression of the hydrogel was performed with a different tensile machine at a speed of 0.05 mm s⁻¹ with a 10N load. The hydrogel sample was compressed up to 15% of displacement for 10 cycles and the compressive stress for each cycle was recorded.

For rheological properties testing, the storage modulus (G′), loss modulus (G″), and phase angle (δ) of the hydrogel were measured across a frequency sweep from 0.1 to 10 Hz with a constant shear strain at 1.0% using a rheometer. The test was conducted at 25° C. with 10 sample readings per decade using spindle CP2/20 L0219 SS.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment.

What is claimed is:

1. An ink product for use in non-extrusion three-dimensional (3D) printing comprising:
a hydrophilic silicone;
at least one type of vinylic monomer;
at least one type of multi-vinylic monomer; and
a water-based initiator.

2. The ink product of claim 1 further comprising at least one additive.

3. The ink product of claim 2 wherein the at least one additive comprises an additive with photoabsorption properties, an additive with mechanical property enhancements, an additive for photoinhibiting or an additive for photocuring depth tuning.

4. The ink product of claim 2 wherein the at least one additive comprises a set of cellulose nanocrystals (CNC), colouring dyes, a hydrophilic nanofiller, clay, silica or radical inhibitors.

5. The ink product of claim 1 wherein the hydrophilic silicone comprises at least one of a silicone grafted with hydrophilic functional groups, aminosilicone, methacryloyl silicone, polyalkene oxide silicone and hydroxylic silicone.

6. The ink product of claim 1 wherein the at least one vinylic monomer comprises at least one of acrylamide monomers, hydrophilic vinylic monomers, acrylic acid, methacrylic acid, glycidyl methacrylate, 2-hydroxyethyl methacrylate (HEMA), 2-hydroxyethyl acrylate (HEA) and vinyl alcohol.

7. The ink product of claim 1 wherein the at least one multi-vinylic monomer comprises at least one of poly(ethylene glycol) dimethacrylate (PEGDMA), any hydrophilic di-acrylate, tri-acrylate, tetra-acrylate, penta-acrylate, hexa-acrylate or methacrylate ethylene glycol dimethacrylate, diethylene glycol dimethacrylate, 1,3-butanediol dimethacrylate and dipentaerythritol hexaacrylate.

8. The ink product of claim 1 wherein the water-based initiator comprises at least one of water-soluble derivatives of monoacylphosphine oxide (MAPO) or water-soluble derivatives of biscylphosphine oxide (BAPO).

9. The ink product of claim 1 wherein the water-soluble derivatives of MAPO comprise lithium phenyl (2,4,6-trimethylbenzoyl) phosphinate (LAP) or sodium diphenyl(2,4,6-trimethylbenzoyl) phosphine oxide (TPO-Na).

10. The ink product of claim 1 wherein the water-soluble derivatives of BAPO comprise BAPO-OLi or BAPO-ONa.

11. A method of fabricating an ink product for use in non-extrusion three-dimensional (3D) printing comprising:
mixing at least one type of vinylic monomer with a hydrophilic silicone to produce a first mixture;
adding at least one type to multi-vinylic monomer to the first mixture to produce a second mixture; and
adding a water-based initiator to the second mixture to produce the ink product.

12. The method of claim 11 further comprising:
adding at least one additive.

13. The method of claim 12 wherein adding at least one additive comprises:
adding at least one of an additive with photoabsorption properties, an additive with mechanical property enhancements, an additive for photoinhibiting or an additive for photocuring depth tuning to the ink product.

14. The method of claim 12 wherein adding at least one additive comprises:
adding at least one of a set of cellulose nanocrystals (CNC), colouring dyes, a hydrophilic nanofiller, clay, silica or radical inhibitors to the ink product.

15. The method of claim 11 wherein the hydrophilic silicone comprises at least one of a silicone grafted with hydrophilic functional groups, aminosilicone, methacryloyl silicone, polyalkene oxide silicone and hydroxylic silicone.

16. The method of claim 11 wherein mixing at least one type of vinylic monomer with a hydrophilic silicone comprises:
mixing at least one of acrylamide monomers, hydrophilic vinylic monomers, acrylic acid, methacrylic acid, glycidyl methacrylate, 2-hydroxyethyl methacrylate (HEMA), 2-hydroxyethyl acrylate (HEA) or vinyl alcohol with the hydrophilic silicone.

17. The method of claim 11 wherein adding at least one type of multi-vinylic monomer to the first mixture comprises:
adding at least one of poly(ethylene glycol) dimethacrylate (PEGDMA), any hydrophilic di-acrylate, tri-acrylate, tetra-acrylate, penta-acrylate, hexa-acrylate or methacrylate ethylene glycol dimethacrylate, diethylene glycol dimethacrylate, 1,3-butanediol dimethacrylate or dipentaerythritol hexaacrylate to the first mixture.

18. The method of claim 11 wherein adding a water-based initiator to the second mixture comprises:
adding at least one of water-soluble derivatives of monoacylphosphine oxide (MAPO) or water soluble derivatives of biscylphosphine oxide (BAPO) to the second mixture.
